(19) United States
(12) Patent Application Publication
(10) Pub. No.: US 2024/0196808 A1
(43) Pub. Date: Jun. 20, 2024

(54) NEW FLUORESCENT POWDER CAPABLE OF PROMOTING PLANT GROWTH UNDER SUNLIGHT, AND PREPARATION AND USE THEREOF

(71) Applicant: LANZHOU UNIVERSITY, Lanzhou, Gansu (CN)

(72) Inventors: Takatoshi SETO, Tsukuba City, Ibaraki Prefecture (JP); Bin LIU, Lanzhou, Gansu (CN); Yuhua WANG, Lanzhou, Gansu (CN); Shichuan WANG, Lanzhou, Gansu (CN)

(21) Appl. No.: 18/287,031

(22) PCT Filed: Apr. 15, 2022
(86) PCT No.: PCT/CN2022/087168

§ 371 Date: Dec. 21, 2023

(30) Foreign Application Priority Data
Apr. 16, 2021 (CN) 202110409340.X

(51) Int. Cl. A01G 7/04; C09K 11/08; C09K 11/55; C09K 11/68

(52) U.S. Cl. CPC A01G 7/04; C09K 11/0838; C09K 11/55; C09K 11/68

(57) ABSTRACT

Disclosed in the present disclosure are a new fluorescent powder capable of promoting plant growth under sunlight and preparation and use thereof. The fluorescent powder has a chemical formula of Sr₄Al₁₄O₂₅: xMn⁴⁺, yMg²⁺, zLn³⁺. Compounds are weighed according to a stoichiometric ratio of various chemical components in the chemical formula; a fluxing agent is added and uniformly mixed; and a resulting mixture is calcined, naturally cooled to room temperature, and then ground to obtain the new fluorescent powder. The fluorescent powder has can emit red light that is conducive to plant growth, improves the utilization rate of sunlight, promotes plant growth, and is low in cost, high in efficiency, green and pollution-free.

### CROSS REFERENCE TO RELATED APPLICATIONS

This application is a national application of PCT/CN2022/087168, filed on Apr. 15, 2022. The contents of PCT/CN2022/087168 are all hereby incorporated by reference.

### TECHNICAL FIELD

The present disclosure belongs to the technical field of luminescent materials, relates to a red luminescent material excited by ultraviolet light and blue light, and in particular to a new fluorescent powder capable of promoting plant growth under sunlight. The present disclosure further relates to a preparation method and use of the fluorescent powder.

### BACKGROUND

A solar spectrum is particularly important for plant growth. Generally, three regions of the solar spectrum are used as irradiation light required for plant growth, including blue light (400-500 nm), red light (620-690 nm) and far red light (730-735 nm), which are used for phototropism, photosynthesis and photomorphogenesis, respectively. An ultraviolet light part (n-UV) and a green light part of the solar spectrum are not used by plants. Therefore, light conversion materials used for plant growth have attracted more and more attention. Most of the light conversion materials are mainly used for obtaining emission bands suitable for plant growth. The light conversion materials used for plant growth have a good application prospect and provide light energy required for growth and development of the plants. Therefore, light regulation is one of important means to regulate plant growth. Plant growth fluorescent powders are fluorescent powders for promoting rapid growth of the plants and shortening a ripening period. The light located in the red light region (620-690 nm) is the most important light for plant growth, because the red light has a great impact on flowering and ripening stages of the plants. The utilization rate of a red light part of sunlight is very low during plant growth. Therefore, improvement of the utilization rate of the red light by the plants has a crucial impact on plant growth, which can increase the growth rate of the plants and increase the yield.

In the prior art, fluorescent powders for promoting plant growth are mostly used in light-emitting diode (LED) lights. In order to better promote growth of cash crops, high-cost red fluorescent powders are used in most of LED plant growth lights. However, the fluorescent powders used in the LED lights have many disadvantages that as spectra of the current LED plant lights on the market have large differences with spectrum curves of light absorbed by the plants during photosynthesis, the utilization rate of light sources is not high, and as LED chips have high price and a lot of power resources are consumed, the planting cost is increased, and energy is wasted. In addition, as the LED plant growth lights contain high-cost fluorescent powders and high-cost LED devices, power supplies and buildings or greenhouses are required to achieve illumination on the plants. Thus, the LED plant growth lights have a higher cost. Therefore, although the crop yield can be increased to a certain extent, indoor LED plant growth factories are not suitable for cultivating some low-cash crops, so that the LED plant growth lights are difficult to be widely used.

Until now, nitrides, such as CaAlSiN₃:Eu, have been used for plant growth. However, the nitrides have high preparation cost and are difficult to be widely used for plant growth.

### SUMMARY

An objective of the present disclosure is to provide a new fluorescent powder capable of promoting plant growth under sunlight, so as to improve the emission intensity and full-spectrum absorption capacity of a fluorescent powder (Sr₄Al₁₄O₂₅: Mn⁴) and meet demands for plant growth.

Another objective of the present disclosure is to provide a preparation method of the fluorescent powder.

A third objective of the present disclosure is to provide use of the fluorescent powder.

In order to realize the above objectives, a technical scheme adopted by the present disclosure is: a new fluorescent powder capable of promoting plant growth under sunlight.

The fluorescent powder has a chemical formula of Sr₄Al₁₄O₂₅: xMn⁴⁺, yMg²⁺, zLn³⁺, where Ln³⁺ is Ga³⁺, Sc³⁺, Cr³⁺ or Lu³⁺, x is equal to or greater than 0.005 and equal to or less than 0.04, y is greater than 0 and equal to or less than 0.2, and z is greater than 0 and equal to or less than 0.7.

The fluorescent powder can be called 4-14-25:MML.

Another technical scheme adopted by the present disclosure is: a preparation method of the fluorescent powder.

The preparation method specifically includes the following steps:
(1) weighing a strontium compound, an aluminum compound, a manganese compound and a magnesium compound according to a stoichiometric ratio of various chemical components in the chemical formula Sr₄Al₁₄O₂₅: xMn⁴⁺,yMg²⁺,zLn³⁺, respectively; then weighing one of a gallium compound, a scandium compound, a chromium compound or a lutetium compound;
where the strontium compound includes strontium carbonate (SrCO₃), hydroxide of strontium, nitrate of strontium, carbonate of strontium, sulfate of strontium or phosphate of strontium;
the aluminum compound includes alumina (Al₂O₃), hydroxide of aluminum, nitrate of aluminum, sulfate of aluminum or phosphate of aluminum;
the manganese compound includes manganese oxide (MnO₂), hydroxide of manganese, nitrate of manganese, sulfate of manganese or phosphate of manganese;
the magnesium compound includes magnesium oxide (MgO), hydroxide of magnesium, nitrate of magnesium, carbonate of magnesium, sulfate of magnesium or phosphate of magnesium;
the gallium compound includes gallium oxide (Ga₂O₃), hydroxide of gallium, nitrate of gallium, carbonate of gallium, sulfate of gallium or phosphate of gallium;
the scandium compound includes scandium oxide (Sc₂O₃), hydroxide of scandium, nitrate of scandium, carbonate of scandium, sulfate of scandium or phosphate of scandium;
the chromium compound includes chromium oxide (Cr₂O₃), hydroxide of chromium, nitrate of chromium, carbonate of chromium, sulfate of chromium or phosphate of chromium;
and the lutetium compound includes lutetium oxide (Lu₂O₃), hydroxide of lutetium, nitrate of lutetium, carbonate of lutetium, sulfate of lutetium or phosphate of lutetium;
grinding the weighed compounds to a micron level, mixing the compounds, adding an H₃BO₃ powder to serve as a fluxing agent, and performing uniform mixing to obtain a raw material powder, where the mass of the H₃BO₃ powder is 9 wt % of the mass of the raw material powder; and
(2) placing the raw material powder obtained in step (1) in an environment in an atmosphere with air introduced therein, calcining the raw material powder for 6 hours after raising the temperature to 1,480° C. at a heating rate of 5° C./min, naturally cooling the raw material powder to room temperature, and then grinding the same to obtain the new fluorescent powder capable of promoting plant growth under sunlight.

A third technical scheme adopted by the present disclosure is: use of the fluorescent powder in promoting plant growth, especially use in growth of tomatoes and growth of chlorellas. When used in growth of tomatoes, the fluorescent powder is prepared into a light conversion film by a preparation method in the prior art, at least two light conversion films are placed at bottoms of tomato plants, the at least two light conversion films are evenly arranged around the tomato plants, and an included angle between the light conversion film and the horizontal plane is 0-60°, preferably 20-60°. When the light conversion film is placed parallel to the horizontal line (that is to say, the included angle between the light conversion film and the horizontal plane is 0°), leaves of the plants block the upper sunlight from reaching the light conversion film. Meanwhile, in a case that the light conversion film is highly inclined at an angle of 90° from the horizontal line, the amount of light irradiated from the upper sunlight to the light conversion film is quite small. Therefore, the optimal angle is 20-60°.

The compound Sr₄Al₁₄O₂₅ is activated by Mn⁴ in Sr₄Al₁₄O₂₅: Mn⁴⁺, wherein hexa-coordinate Al³⁺ in the Sr₄Al₁₄O₂₅ is replaced by the Mn⁴¹. However, the Mn⁴⁺ has charge imbalance with the Al³⁺.

According to the fluorescent powder of the present disclosure, charge compensation is achieved by doping with Mg²⁺, Mg²⁺—Mn⁴⁺ occupy the position of 2Al³⁺ to achieve charge balance, and the Mg²⁺ as a charge compensator has a crucial impact on luminescence properties. Ln³⁺ has an ionic radius (0.0535 nm) similar to that of the hexa-coordinate Al³⁺, which can well replace the hexa-coordinate Al³⁺. Meanwhile, structural symmetry around the Mn⁴⁺ is broken by doping with the Ln³⁺, forbidden transition of a 3d orbit is broken, and energy loss of non-radiative transition is also reduced, thereby greatly improving the luminescence properties. Accordingly, the luminous intensity is increased by 578.64% compared with that of the Sr₄Al₁₄O₂₅: Mn⁴⁺ in the prior art.

After introduction of Ga³⁺, d-d parity forbidden transition is changed into parity allowed transition, and a distance between luminous centers is increased, thereby suppressing the generation of non-radiative transition and improving the luminescence properties of the fluorescent powder.

The fluorescent powder of the present disclosure is obtained by calcination at high temperature, has the advantages of a simple production process, simple equipment operation, a low cost, no generation of harmful substances, a green effect, environmental friendliness and high luminous intensity, and can emit dark red light that is conducive to plant growth under the irradiation of sunlight. The fluorescent powder has an excitation spectrum in a wide coverage area, which can be directly excited by visible light without making a chip. The emission intensity of the fluorescent powder in a red light region is greatly improved, and more convenience is provided for promoting plant growth. The fluorescent powder is sintered in air without introducing a protective gas and a reducing gas, thereby reducing the preparation cost and ensuring production safety.

### BRIEF DESCRIPTION OF THE DRAWINGS

FIG. 1 shows comparison between an X-ray diffraction (XRD) pattern of a fluorescent powder prepared in Comparative Example and a standard card.

FIG. 2 shows an excitation spectrum and an emission spectrum of the fluorescent powder prepared in Comparative Example.

FIG. 3 shows comparison between XRD patterns of fluorescent powders prepared in Examples 1-4 and a standard card.

FIG. 4 shows comparison between emission spectra of the fluorescent powders prepared in Examples 1-4 and the fluorescent powder prepared in Comparative Example.

FIG. 5 shows comparison between emission spectra of the fluorescent powder prepared in Example 1 and the fluorescent powder prepared in Comparative Example.

FIG. 6 shows a spectrum of sunlight.

FIG. 7 shows an emission spectrum of the fluorescent powder (Sr₄Al₁₄O₂₅: Mn⁴⁺,Mg²⁺, Ga³⁺) of the present disclosure, a chlorophyll a absorption spectrum and a chlorophyll b absorption spectrum.

FIG. 8 shows optical density (OD) value curves of chlorellas after cultivation for 7 days.

FIG. 9 shows transmission of a light conversion film and reflection of a lining plate.

FIG. 10 shows a tomato growth experiment.

FIG. 11 shows comparison of the ripeness of tomato fruits after completion of the tomato growth experiment as shown in FIG. 10.

### DETAILED DESCRIPTION OF THE EMBODIMENTS

The present disclosure is described in detail below in combination with accompanying drawings and specific embodiments.

### COMPARATIVE EXAMPLE

1.9649 g of SrCO₃, 2.3750 g of Al₂O₃ and 0.004 g of MnO₂ were weighed according to a stoichiometric ratio shown in a chemical formula Sr₄Al_{13.9625}: 0.014Mn⁴⁺, the weighed raw materials were fully ground and mixed, and an H₃BO₃ powder was added and uniformly mixed to obtain a raw material powder. The raw material powder was placed in an alumina crucible, put into a tube furnace, calcined for 6 hours after the temperature was raised to 1,480° C. at a heating rate of 5° C./min under an air atmosphere, and then cooled to room temperature with the furnace to obtain a calcined product. Then, the calcined product was ground to obtain a fluorescent powder.

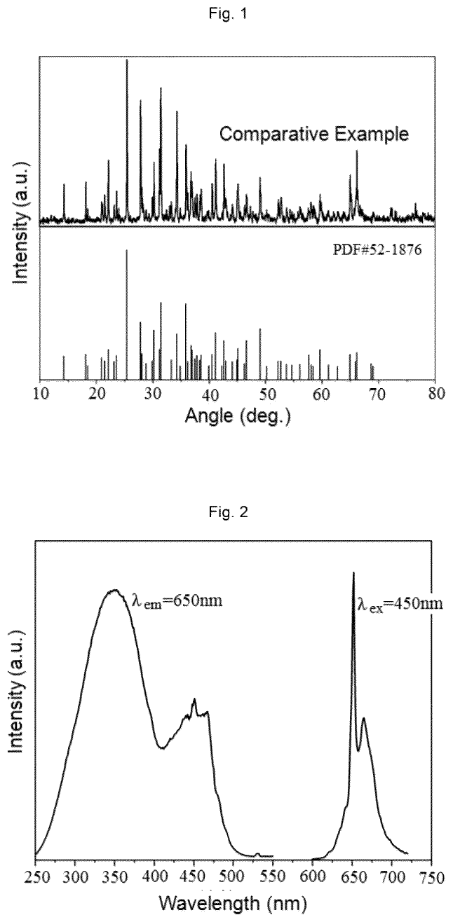

An XRD pattern of the fluorescent powder prepared in Comparative Example is shown in FIG. 1. The shape and position of each peak in the figure correspond to those in a portable document format (PDF) card one by one, proving that the prepared powder is present in a single phase.

An excitation spectrum and an emission spectrum of the fluorescent powder prepared in Comparative Example are shown in FIG. 2. The excitation spectrum shows two wide peaks, and excitation peaks have peak values at 350 nm and 450 nm, respectively. The emission spectrum shows two emission peaks, in which a narrow peak with the highest intensity is located at 650 nm. It can be found from the spectrogram that the fluorescent powder (Sr_{3.993}Al_{13.976}O₂₅: 0.014Mn⁴⁺) can be excited by light in a wavelength range of 310-380 nm and 380-520 nm, which has a wide excitation area. Moreover, the fluorescent powder has absorption under ultraviolet light at 310-380 nm, thereby avoiding yellowing and disintegration of a film caused by sunlight. In the emission spectrum, the fluorescent powder emits red light with a wavelength of about 650 nm and 670 nm.

### Example 1

1.9245 g of SrCO₃, 2.2690 g of Al₂O₃, 0.004 g of MnO₂, 0.00094 g of MgO and 0.003124 g of Ga₂O₃ were weighed according to a stoichiometric ratio shown in a chemical formula Sr₄Al_{13.969}O₂₅: 0.014Mn⁴⁺, 0.007Mg²⁺, 0.01Ga³⁺, ground and mixed, and an H₃BO₃ powder was added and uniformly mixed to obtain a raw material powder, where the mass of the H₃BO₃ powder was 9 wt % of the mass of the raw material powder. The raw material powder was placed in an alumina crucible, put into a tube furnace, calcined for 6 hours after the temperature was raised to 1,480° C. at a heating rate of 5° C./min under an air atmosphere, and then cooled to room temperature with the furnace to obtain a calcined product. Then, the calcined product was ground to obtain a new fluorescent powder capable of promoting plant growth under sunlight.

### Example 2

1.9245 g of SrCO₃, 2.2690 g of Al₂O₃, 0.004 g of MnO₂, 0.00094 g of MgO and 0.006632 g of Lu₂O₃ were weighed according to a stoichiometric ratio shown in a chemical formula Sr₄Al_{13.969}O₂₅: 0.014Mn⁴⁺, 0.007Mg²⁺, 0.01 Lu³⁺, ground and mixed, and an H₃BO₃ powder was added and uniformly mixed to obtain a raw material powder, where the mass of the H₃BO₃ powder was 9 wt % of the mass of the raw material powder. The raw material powder was placed in an alumina crucible, put into a tube furnace, calcined for 6 hours after the temperature was raised to 1,480° C. at a heating rate of 5° C./min under an air atmosphere, and then cooled to room temperature with the furnace to obtain a calcined product. Then, the calcined product was ground to obtain a new fluorescent powder capable of promoting plant growth under sunlight.

### Example 3

1.9245 g of SrCO₃, 2.2690 g of Al₂O₃, 0.004 g of MnO₂, 0.00094 g of MgO and 0.002288 g of Sc₂O₃ were weighed according to a stoichiometric ratio shown in a chemical formula Sr₄Al_{13.969}O₂₅: 0.014Mn⁴⁺, 0.007Mg²⁺, 0.01Sc³⁺ and mixed, and an H₃BO₃ powder was added and uniformly mixed to obtain a raw material powder, where the mass of the H₃BO₃ powder was 9 wt % of the mass of the raw material powder. The raw material powder was placed in an alumina crucible, put into a tube furnace, calcined for 6 hours after the temperature was raised to 1,480° C. at a heating rate of 5° C./min under an air atmosphere, and then cooled to room temperature with the furnace to obtain a calcined product. Then, the calcined product was ground to obtain a new fluorescent powder capable of promoting plant growth under sunlight.

### Example 4

1.9245 g of SrCO₃, 2.2690 g of Al₂O₃, 0.004 g of MnO₂, 0.00094 g of MgO and 0.002522 g of Cr₂O₃ were weighed according to a stoichiometric ratio shown in a chemical formula Sr₄Al_{13.969}O₂₅: 0.014Mn⁴⁺, 0.007Mg²⁺, 0.01Cr³⁺ and mixed, and an H₃BO₃ powder was added and uniformly mixed to obtain a raw material powder, where the mass of the H₃BO₃ powder was 9 wt % of the mass of the raw material powder. The raw material powder was placed in an alumina crucible, put into a tube furnace, calcined for 6 hours after the temperature was raised to 1,480° C. at a heating rate of 5° C./min under an air atmosphere, and then cooled to room temperature with the furnace to obtain a calcined product. Then, the calcined product was ground to obtain a new fluorescent powder capable of promoting plant growth under sunlight.

### Example 5

SrCO₃, Al₂O₃, MnO₂, MgO and Cr₂O₃ were weighed according to a stoichiometric ratio shown in a chemical formula Sr₄Al_{13.095}O₂₅: 0.005Mn⁴⁺, 0.2Mg²⁺, 0.7Cr³⁺, respectively, and a new fluorescent powder capable of promoting plant growth under sunlight was prepared by the method in Example 1.

### Example 6

SrCO₃, Al₂O₃, MnO₂, MgO and Cr₂O₃ were weighed according to a stoichiometric ratio shown in a chemical formula Sr₄Al_{13.095}O₂₅: 0.04Mn⁴⁺, 0.1Mg²⁺, 0.35Cr³⁺, respectively, and a new fluorescent powder capable of promoting plant growth under sunlight was prepared by the method in Example 2.

### Example 7

SrCO₃, Al₂O₃, MnO₂, MgO and Cr₂O₃ were weighed according to a stoichiometric ratio shown in a chemical formula Sr₄Al₁₃₉₇₅O₂₅: 0.023Mn⁴⁺, 0.001Mg²⁺, 0.001Cr³⁺, respectively, and a new fluorescent powder capable of promoting plant growth under sunlight was prepared by the method in Example 3.

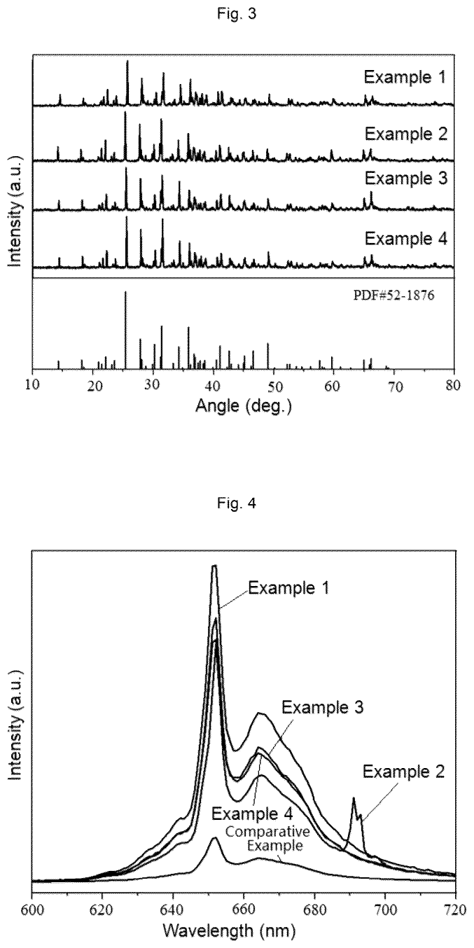

XRD patterns of the fluorescent powder prepared in Example 1, the fluorescent powder prepared in Example 2, the fluorescent powder prepared in Example 3 and the fluorescent powder prepared in Example 4 are shown in FIG. 3. The shape and position of each peak in the figure correspond to those in a PDF card one by one, proving that the fluorescent powders prepared in Examples 1-4 are present in a single phase. Comparison between emission spectra of the fluorescent powders prepared in Examples 1-4 and the fluorescent powder prepared in Comparative Example is shown in FIG. 4. It can be seen from FIG. 4 that the luminous intensity of the fluorescent powders prepared in Examples 1-4 is improved by 500% or above compared with that of the fluorescent powder prepared in Comparative Example.

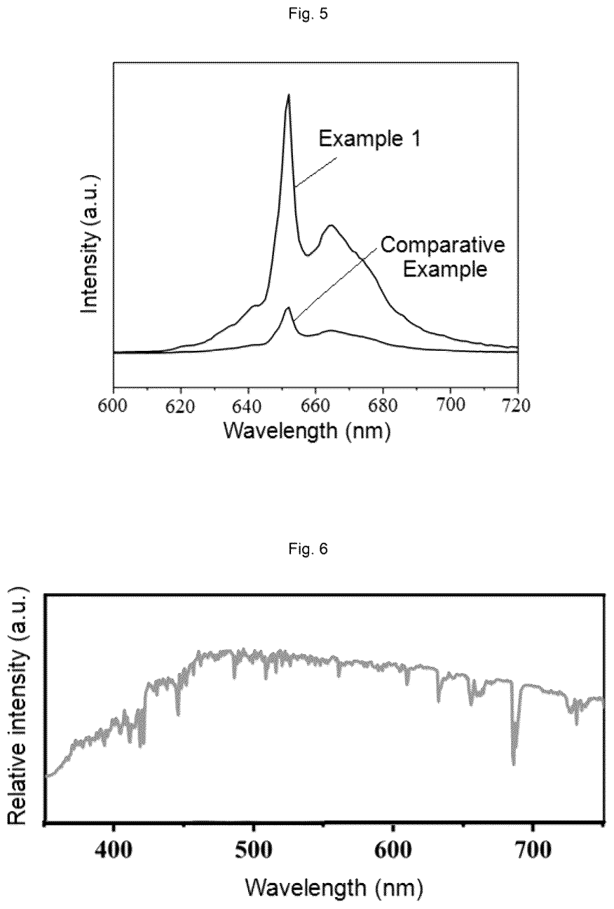

Comparison between emission spectra of the fluorescent powder prepared in Example 1 and the fluorescent powder prepared in Comparative Example is shown in FIG. 5. It can be seen that the luminous intensity of the fluorescent powder prepared in Example 1 is improved by 568.64% compared with that of the fluorescent powder prepared in Comparative Example.

Alight conversion film was prepared by adding the fluorescent powder of the present disclosure based on a preparation method in the prior art.

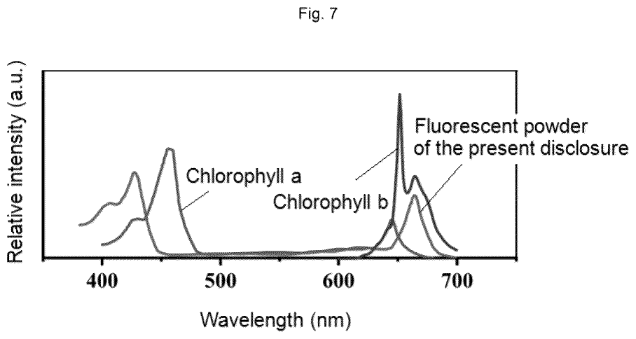

A spectrum of sunlight is shown in FIG. 6. It can be seen that a blue light part of sunlight has the highest intensity. Based on regulation of luminescence properties, a new red fluorescent powder (Sr₄Al_{13.969}O₂₅: 0.014Mn⁴⁺, 0.007Mg²⁺, 0.01Ga³⁺) with excellent luminescence properties is successfully prepared in the present disclosure. Moreover, the red fluorescent powder can be effectively excited by blue light and has an emission spectrum covering an absorption range (600-700 nm) of chlorophyll in plants. Meanwhile, emission peak positions of the red fluorescent powder are matched with absorption bands of chlorophyll a and chlorophyll b, as shown in FIG. 7. Therefore, the light conversion film prepared from the fluorescent powder of the present disclosure can be excited by sunlight outdoors to emit red light capable of promoting plant growth.

The fluorescent powders prepared by designing different raw materials based on the preparation method of the present disclosure have similar properties and technical effects.

Based on the above theoretical analysis, a tomato growth experiment and a chlorella growth experiment were carried out.

### 1. Chlorella Growth Experiment

As one of green unicellular algae, chlorellas have become a hot spot in biological cultivation in recent years. Different from traditional land cultivation, the chlorellas grow and reproduce in a water environment and are applicable to growth in an alkaline environment with full sunlight at a temperature of about 30° C. The chlorellas grow in a cell division mode, thus having a high reproduction rate. CO₂ is required to be introduced continuously in a cultivation process. The chlorellas contain more chlorophyllinites, and light plays a decisive role on growth of the chlorellas. Most plants have long growth cycles, while the chlorellas usually have a cultivation cycle of 7 days, so that convenience is provided to carry out a growth experiment, and several experiments can be carried out in a short period of time.

In order to ensure full sunlight and suitable outdoor temperature, a chlorella growth experiment was carried out outdoors in August. A total of 5 groups were used in the experiment, in which Group 4 and Group 5 were used as blank control groups. Groups 1-3 were used as experimental groups. Group 2 using a light conversion film prepared from a commercial red nitride fluorescent powder (Sr₂Si₅N_{B}: Eu2+ was used as an experimental control group, Group 3 using a light conversion film prepared from a commercial red nitride fluorescent powder (CaAlSiN₃: Eu²⁺) was used as an experimental control group, and a light conversion film prepared from a fluorescent powder (Sr₄Al_{13.969}O₂₅: 0.014Mn⁴⁺, 0.007Mg²⁺, 0.01Ga³⁺) of the present disclosure was used in Group 1.

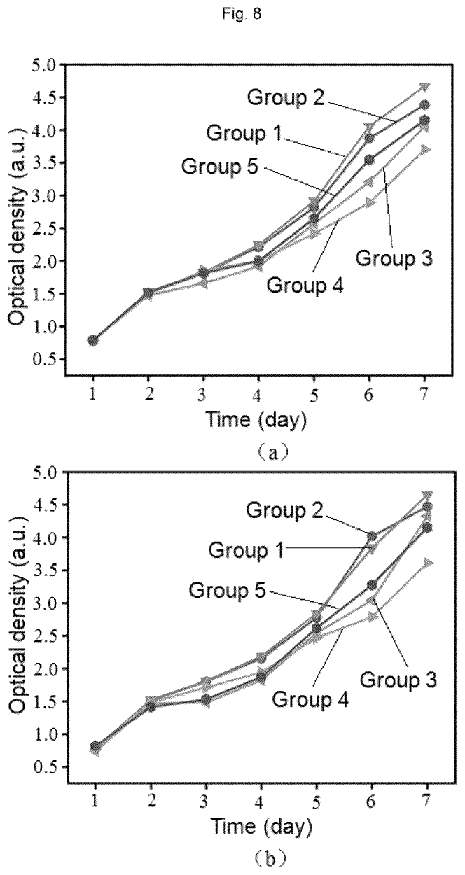

The experiment was carried out for two times (for 7 days each time). CO₂ was continuously and uniformly introduced during growth of chlorellas, and after growth for 7 days, an optical density value (OD value) was tested to characterize the final concentration of the chlorellas. Experimental results are shown in FIG. 8. Fig. a in FIG. 8 shows OD value curves of the chlorellas after cultivation for 7 days for the first time, and Fig. b in FIG. 8 shows OD value curves of the chlorellas after cultivation for 7 days for the second time. Compared with the blank control groups, in the two experiments, the growth rate of the chlorellas is increased by 24% and 26% by using the light conversion film prepared from the fluorescent powder of the present disclosure, respectively. Compared with the two commercial red fluorescent powders, the growth rate of the chlorellas is increased by about 15% by using the light conversion film prepared from the fluorescent powder of the present disclosure. The experimental results show that the light conversion film prepared from the fluorescent powder (Sr₄Al_{13.969}O₂₅: 0.014Mn⁴⁺, 0.007Mg²⁺, 0.01Ga³⁺) of the present disclosure has an obvious effect on promoting growth of chlorellas, and the growth rate reaches about 25%.

### 2. Tomato Growth Experiment

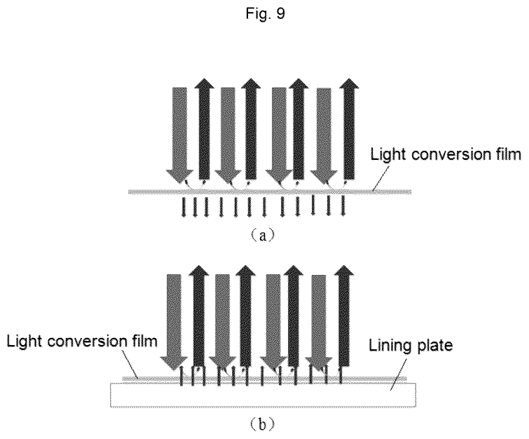

No matter transmission type light conversion films or reflection type light conversion films have light loss due to reflection, transmission, or refraction of partial light (as shown in Fig. a in FIG. 9). A reflection type light conversion film is used in the present disclosure. In order to reduce decrease of conversion efficiency caused by transmission of partial light, a lining plate behind the light conversion film is required to be used to reflect the transmitted light again (as shown in Fig. b in FIG. 9). The lining plate not only needs to have good plasticity and can fit with the film conversion film, but also needs to be prepared from a smooth white material to ensure that the transmitted light is completely reflected back. A Teflon plate is used as the lining plate for the light conversion film in the present disclosure. When blue light in the sunlight irradiated on the light conversion film is converted into red light required by plants, a part of the red light is reflected on the plants, while another part of the red light is transmitted through the light conversion film and is then lost. After a Teflon lining plate is installed behind the light conversion film, some of the transmitted red light is refracted and reflected back to the plants again, thereby further improving the light conversion efficiency.

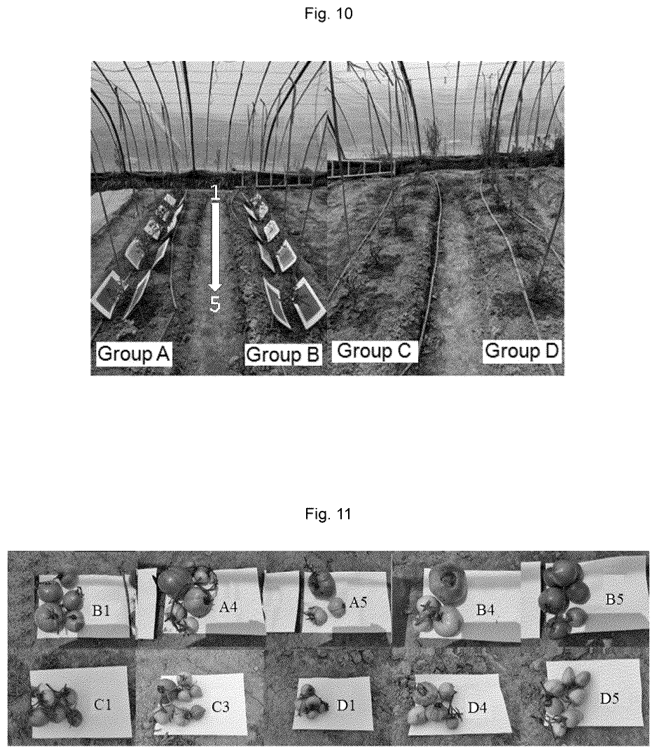

A tomato growth experiment was carried out with full sunlight in April, and four groups, including Group A, Group B, Group C and Group D, were set, as shown in FIG. 10. 1 to 5 shown in FIG. 10 are numbers of tomato seedlings in each group in the experiment. Light conversion films prepared from a fluorescent powder (Sr₄Al_{13.969}O₂₅: 0.014Mn⁴⁺, 0.007Mg²⁺, 0.01Ga³) of the present disclosure were used for A1 (No. 1 in Group A) and B1 (No. 1 in Group B) in the experiment. The mass percentage of the fluorescent powder of the present disclosure in the light conversion film of A1 was 20%, and the mass percentage of the fluorescent powder of the present disclosure in the light conversion film of B1 was 30%. Group C and Group D were used as blank control groups. The mass percentage of a commercial fluorescent powder (CaAlSiN₃: Eu²⁺) in a light conversion film of A4 was 20%, and the mass percentage of a commercial fluorescent powder (CaAlSiN₃: Eu²⁺) in a light conversion film of B4 was 30%. The mass percentage of a commercial fluorescent powder (Sr₂Si₅N₈: Eu²) in a light conversion film of A5 was 20%, and the mass percentage of a commercial fluorescent powder (Sr₂Si₅N₈: Eu²⁺) in a light conversion film of B5 was 30%. A commercial red fluorescent powder was used as an experimental control group. Two light conversion films were placed at bottoms of tomato plants, the two light conversion films were placed on two sides of the tomato plants, respectively, and an included angle between the light conversion film and the horizontal plane was 0-60°, preferably 20-60°. No pesticides and chemical fertilizers were sprayed during the experiment, and the experiment was carried out in a period of 85 days. A promotion effect was characterized by the ripeness and weight of fruits.

Four tomato plants in the control group died during the experiment. After completion of the growth experiment, one tomato plant in the control group had no fruits, while only five plants had fruits in the blank control groups. FIG. 11 shows comparison of ripeness situations of tomato fruits in experimental groups and control groups. It can be clearly seen from the figure that most of tomato fruits in the experimental groups are ripe, while almost all of fruits in the control groups are unripe, indicating that the light conversion film has an obvious effect on promoting ripening of tomato fruits, where the weight and ripeness of the fruits using the light conversion film prepared from the fluorescent powder (Sr₄Al_{13.969}O₂₅: 0.014Mn⁴⁺, 0.007Mg²⁺, 0.01Ga³⁺) with a content of 30% are slightly lower than those of the fruits using the light conversion film prepared from the fluorescent powder (Sr₂Si₅N₈: Eu²⁺) with a content of 30%. Based on the above experimental results and analysis, it is shown that the light conversion film prepared from the red fluorescent powder has an obvious effect on promoting growth of tomatoes, and the fruits are ripe in advance, and a yield increase effect is achieved. Compared with high-cost nitrides, the fluorescent powder (Sr₄Al_{13.969}O₂₅: 0.014Mn⁴⁺, 0.007Mg²⁺, 0.01Ga³⁺) of the present disclosure has a cost of only 25% of that of the nitrides and is more suitable for preparing a light conversion film for promoting plant growth.

After completion of the tomato growth experiment, the weight of the tomato fruits was calculated by statistics, as shown in Table 1.

TABLE 1
Statistical table of the weight of tomato fruits

| Unit/gram | 1 | 3 | 4 | 5 |
|---|---|---|---|---|
| A | 762 | | 846 | 477 |
| B | 873 | | 514 | 908 |
| C | 383 | 659 | | |
| D | 323 | | 501 | 532 |

Table 1 is a statistical table of the weight of tomato fruits in experimental groups and control groups after completion of a growth experiment. Compared with the control groups, the yield of Al (using 20% of Sr₄Al_{13.969}O₂₅, 0.014Mn⁴⁺, 0.007Mg²⁺, 0.01Ga³⁺) is increased by about 25%, and the yield of B1 (using 30% of Sr₄Al_{13.969}O₂₅: 0.014Mn⁴⁺, 0.007Mg²⁺, 0.01Ga³⁺) is increased by about 30%.

The above experimental results show that the light conversion film prepared from the fluorescent powder (Sr₄Al_{13.969}O₂₅: 0.014Mn⁴⁺, 0.007Mg²⁺, 0.01Ga³⁺) of the present disclosure has an obvious effect on promoting ripening of tomato fruits.

1. Anew fluorescent powder capable of promoting plant growth under sunlight, wherein the new fluorescent powder has a chemical formula of:
Sr₄Al₁₁O₂₅: xMn⁴⁺, yMg²⁺, zLn³⁺, wherein Ln³⁺ is Ga³⁺, Sc³⁺, Cr³⁺ or Lu³⁺, x is equal to or greater than 0.005 and equal to or less than 0.04, y is greater than 0 and equal to or less than 0.2, and z is greater than 0 and equal to or less than 0.7.

2. The new fluorescent powder capable of promoting plant growth under sunlight according to claim 1, wherein the Ln³⁺ is Ga³⁺.

3. The new fluorescent powder capable of promoting plant growth under sunlight according to claim 1, wherein when the new fluorescent powder is used, the new fluorescent powder is prepared into a light conversion film with resin, a reflection film is arranged below the light conversion film, and a system composed of the reflection film and the light conversion film is capable of converting sunlight into red light with a wavelength of 650-700 mn.

4. A preparation method of the new fluorescent powder capable of promoting plant growth under sunlight according to claim 1, wherein the preparation method specifically comprises the following steps:
(1) weighing a strontium compound, an aluminum compound, a manganese compound and a magnesium compound according to a stoichiometric ratio of various chemical components in a chemical formula, respectively;
then weighing a gallium compound, a scandium compound, a chromium compound or a lutetium compound;
grinding the weighed compounds to a micron level, mixing the compounds, adding an H₃BO₃ powder and performing uniform mixing to obtain a raw material powder; and
(2) placing the raw material powder obtained in step (1) in a tube furnace in an atmosphere with air introduced therein, calcining the raw material powder for 6 hours at a temperature of 1,480° C., naturally cooling the raw material powder to room temperature, and then grinding the same to obtain the new fluorescent powder capable of promoting plant growth under sunlight.

5. The preparation method of the new fluorescent powder capable of promoting plant growth under sunlight according to claim 4, wherein in step (1),
the strontium compound comprises strontium carbonate, hydroxide of strontium, nitrate of strontium, carbonate of strontium, sulfate of strontium or phosphate of strontium;
the aluminum compound comprises alumina, hydroxide of aluminum, nitrate of aluminum, sulfate of aluminum or phosphate of aluminum;
the manganese compound comprises manganese oxide, hydroxide of manganese, nitrate of manganese, sulfate of manganese or phosphate of manganese;
the magnesium compound comprises magnesium oxide, hydroxide of magnesium, nitrate of magnesium, carbonate of magnesium, sulfate of magnesium or phosphate of magnesium;
the gallium compound comprises gallium oxide, hydroxide of gallium, nitrate of gallium, carbonate of gallium, sulfate of gallium or phosphate of gallium;
the scandium compound comprises scandium oxide, hydroxide of scandium, nitrate of scandium, carbonate of scandium, sulfate of scandium or phosphate of scandium;
the chromium compound comprises chromium oxide, hydroxide of chromium, nitrate of chromium, carbonate of chromium, sulfate of chromium or phosphate of chromium;
and the lutetium compound comprises lutetium oxide, hydroxide of lutetium, nitrate of lutetium, carbonate of lutetium, sulfate of lutetium or phosphate of lutetium.

6. The preparation method of the new fluorescent powder capable of promoting plant growth under sunlight according to claim 4, wherein in step (1), the mass of the H₃BO₃ powder is 9 wt % of the mass of the raw material powder.

7. The preparation method of the new fluorescent powder capable of promoting plant growth under sunlight according to claim 4, wherein in step (2), the temperature is raised to 1,480° C. at a heating rate of 5° C./min.

8. Use of the new fluorescent powder capable of promoting plant growth under sunlight according to claim 1, wherein the new fluorescent powder is used in growth of tomatoes and growth of chlorellas.

9. The use of the new fluorescent powder capable of promoting plant growth under sunlight according to claim 8, wherein when used in growth of tomatoes, the fluorescent powder is prepared into a light conversion film by a preparation method in the prior art, at least two light conversion films are evenly placed around bottoms of tomato plants, and an included angle between the light conversion film and the horizontal plane is 0-60°.

10. The use of the new fluorescent powder capable of promoting plant growth under sunlight according to claim 9, wherein the included angle between the light conversion film and the horizontal plane is 20-60°.

11. The new fluorescent powder capable of promoting plant growth under sunlight according to claim 2, wherein when the new fluorescent powder is used, the new fluorescent powder is prepared into a light conversion film with resin, a reflection film is arranged below the light conversion film, and a system composed of the reflection film and the light conversion film is capable of converting sunlight into red light with a wavelength of 650-700 nm.

12. The new fluorescent powder capable of promoting plant growth under sunlight according to claim 1, wherein the new fluorescent powder has a chemical formula of: Sr₄Al_{130.969}O₂₅: 0.014Mn⁴⁺, 0.007Mg², 0.01Ln³⁺.

13. The new fluorescent powder capable of promoting plant growth under sunlight according to claim 1, wherein the new fluorescent powder has a chemical formula of: Sr₄Al_{13.969}O₂₅: 0.014Mn⁴⁺, 0.007Mg²⁺, 0.01Ga³⁺.

14. The new fluorescent powder capable of promoting plant growth under sunlight according to claim 1, wherein the new fluorescent powder has a chemical formula of: Sr₄Al_{13.969}O₂₅: 0.014Mn⁴⁺, 0.007Mg²⁺, 0.01Lu³⁺.

15. The new fluorescent powder capable of promoting plant growth under sunlight according to claim 1, wherein the new fluorescent powder has a chemical formula of: Sr₄Al_{13.96}O₂₅: 0.014Mn⁴⁺, 0.007Mg²⁺, 0.01Sc³⁺.

16. The new fluorescent powder capable of promoting plant growth under sunlight according to claim 1, wherein the new fluorescent powder has a chemical formula of: Sr₄Al₁₃₆₉O₂₅: 0.014Mn⁴⁺, 0.007Mg²⁺, 0.01Cr³⁺.

17. The new fluorescent powder capable of promoting plant growth under sunlight according to claim 1, wherein the new fluorescent powder has a chemical formula of: Sr₄Al_{13.095}O₂₅: 0.005Mn⁴⁺, 0.2Mg²⁺, 0.7Cr³⁺.

18. The new fluorescent powder capable of promoting plant growth under sunlight according to claim 1, wherein the new fluorescent powder has a chemical formula of: Sr₄Al_{13.975}O₂₅: 0.04Mn⁴⁺, 0.1Mg²⁺, 0.35Cr³⁺.

19. The new fluorescent powder capable of promoting plant growth under sunlight according to claim 1, wherein the new fluorescent powder has a chemical formula of: Sr₄Al_{13.975}O₂₅: 0.023Mn⁴⁺, 0.001Mg²⁺, 0.001Cr³⁺.
